(19) United States
(12) Patent Application Publication
(10) Pub. No.: US 2009/0083826 A1
(43) Pub. Date: Mar. 26, 2009

(54) UNSOLICITED COMMUNICATION MANAGEMENT VIA MOBILE DEVICE

(75) Inventor: Gregory P. Baribault, Lynnwood, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/859,274

(22) Filed: Sep. 21, 2007

(51) Int. Cl. G06F 7/04

(52) U.S. Cl. 726/1

(57) ABSTRACT

A system that can effectively screen or filter incoming communications to a mobile device is disclosed. The innovation can filter voice calls, emails, instant messages, text messages, etc. via a mobile device (e.g., cellular telephone, smartphone, personal digital assistant (PDA), notebook computer). In accordance with the innovation, callers (or senders) are prompted to prove their ‘identity’ as an acceptable (or authorized) identity in order to be permitted to communicate with a mobile device. Accordingly, the innovation prompts a caller (or sender) with a challenge that requires a human input (e.g., human interactive programming (HIP)), which can effectively filter automated machine communication as well as unwanted human communication such as spam. This filtering can be based on most any policy, rule, context-awareness factor.

### BACKGROUND

The Internet has spawned many communication mediums that continue to become increasingly popular and wide spread. The ever-growing popularity of mobile devices such as internet-capable smartphones, personal digital assistants (PDAs) and the like have contributed to this continued popularity. These communication mediums include but are not limited to electronic mail (email), voice-over-Internet-Protocol (VoIP), instant messaging (IM) and text messaging over a network of two or more computers or network connectable, processor-based devices. For example, email allows electronic communication of a text message alone or in combination with graphics and optional attachments. Text or instant messaging is a simpler communication mechanism for transmitting short messages. These electronic communication mediums are popular as they provide inexpensive, easy, point-to-point communication (or point to multi-point) that may be less intrusive than a traditional phone call. There is an abundance of other benefits, for example, email easily enables one-to-many communication, there is no need to synchronize participants and the content can be planned easier, among other things. Unfortunately, these mediums have two main adversaries that threaten the convenience of and confidence in their use, namely spam and viruses.

Spam is the electronic relative of traditional junk mail. Like junk mail, spam is unsolicited messages that are most often sent in bulk. Typically, spam is commercial in nature. For example, direct marketers, companies, and individuals often employ spam to advertise products, get-rich-quick schemes and the like as well as solicit donations. Due to the nature of spam, that is unwanted messages, and the pure volume thereof, spam is a nuisance that inconveniences users of electronic communication mediums Not only do users have to waste time sorting through a deluge of undesired communications, but also they likely bear the cost (passed on by service providers) of the tremendous amounts of resources (e.g., storage space, network bandwidth . . . ) required to cope with these messages. Furthermore, a large volume of spam can have the effect of a denial of service attack, because the real mail is lost in the mass of other messages.

In addition to spam, electronic communication systems are susceptible to virus and other types of malicious code such as worms, viruses and other malware. For instance, a message such as an email can include a virus as an attachment. A computer can subsequently be infected with the virus upon execution, for example, upon opening the attachment. The virus can then damage hardware, software, and/or files. Still further, a virus can perform activities which impact the user's service bill such as sending (and receiving) data, placing calls, etc. Additionally they may send personal information from the device to a service designed to steal personal data.

The virus can thereafter be transferred and spread to other computers via email. A worm is similar to a virus in its devastating effects but can replicate and transmit itself to other computers without aid. For example, a worm can locate a user's address book and send itself to every listed recipient. A ‘Trojan’ or ‘Trojan Horse’ is slightly different in that it employs trickery to lure a user to open or execute the code and does not infect files like a virus or replicate itself like a worm. Rather, a Trojan appears as a legitimate piece of software that when opened can delete or destroy files as well as open a backdoor that can be utilized to access personal or confidential information and/or hijack a computer or device.

A variety of systems and techniques have been developed and employed to combat spam and malicious code. More specifically, most often, filters (e.g., white lists, black lists) are used to prescreen email and text messages in an effort to detect spam and/or malicious code. Once identified, action is taken on the content such as redirection to a designated location (e.g., spam folder, quarantine region . . . ) and/or deletion, among other things.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can effectively screen or filter incoming communications to a mobile device. For example, the innovation can filter voice calls, emails, instant messages, text messages, etc. into a mobile device. As used herein, a mobile device is intended to include, but not limited to, a cellular telephone, smartphone, personal digital assistant (PDA), notebook computer, or the like. Additionally, many of the features functions and benefits of the innovation can be applied to desktop computers and networks without departing from the spirit and/or scope of the innovation.

More particularly, as many users consider their mobile device personal in nature and therefore reserve communication time for personal (or other desired (e.g., business, . . . ) communications, the innovation enables callers or senders to prove their identity as an acceptable (or authorized) identity in order to be permitted to call into a mobile device. Accordingly, the innovation can prompt a caller (or sender) with a challenge that requires a human input (e.g., human interactive programming (HIP)), which can effectively filter out automated (and unsolicited) machine communication as spam.

In another aspect of the subject innovation, ‘identity’ of a caller or sender can be authenticated prior to permitting access to a mobile device. The ‘identity’ can be digital identity of a device or physiological identity of a user. In alternative embodiments, physiological identity can be accomplished via sensory mechanisms capable of capturing and analyzing personal data such as biometric data as well as certificates, signatures or the like. In these examples, biometric data can include, but is not limited to, fingerprint data, retinal scans, facial scans, voice analysis, handwriting analysis, etc.

A policy component (e.g., rules-based decision) can be employed to enforce preferences with regard to authorization. In yet another aspect thereof, an artificial intelligence component (e.g., machine learning and reasoning) is provided that employs a probabilistic and/or statistical-based analysis to prognose or infer an action that a user desires to be automatically performed. Still further, contextual awareness can be employed to manage access via a mobile device.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that facilitates authenticating incoming communication in accordance with an aspect of the innovation.

FIG. 2 illustrates an example flow chart of procedures that facilitate authenticating incoming communication in accordance with an aspect of the innovation.

FIG. 3 illustrates an example flow chart of procedures that facilitate analyzing incoming communication in accordance with an aspect of the innovation.

FIG. 4 illustrates an example block diagram of a human interactive programming (HIP) component in accordance with an aspect of the innovation.

FIG. 5 illustrates an example challenge generation component in accordance with an embodiment of the innovation.

FIG. 6 illustrates an example response receipt component that employs multiple input components in accordance with an embodiment of the innovation.

FIG. 7 illustrates an example authentication component that employs a comparison component and an analysis component in accordance with an aspect of the innovation.

FIG. 8 illustrates an example mobile device that employs a HIP component, an authentication component and an optional machine learning & reasoning (MLR) component that automates one or more features in accordance with an embodiment of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

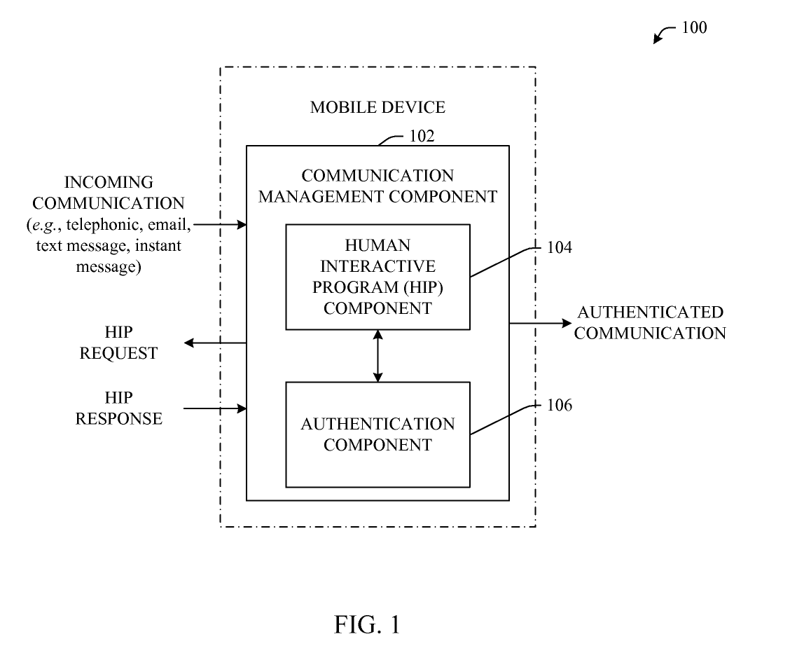

Referring initially to the drawings, FIG. 1 illustrates a system 100 that facilitates managing spam (and other unwanted, unsolicted) communications (e.g., realtime and non-realtime) via a mobile device. Generally, the system 100 includes a communication management component 102 having a human interactive program (HIP) component 104 and an authentication component 106 therein. Together, these components (104, 106) can verify ‘identity’ of a user thereby increasing confidence levels with regard to incoming communications. It will be understood that many consider their cellular phones very personal such that they are selective with who can contact them via the phone. As will be understood, in accordance with establishing identity (e.g., digital, physiological), a user (or device) can intelligently decide whether to accept incoming communications or not.

The HIP component 104 can employ interactive computing techniques in order to establish identity of a user (or user device). For instance, the HIP component 104 can generate a challenge by which a sender will have to appropriately or successfully respond with human input in order to gain access through the communication management component 102.

As will be understood, a challenge/response refers to protocols in which one party presents a question or ‘challenge’ and another party must provide a valid answer or ‘response’ in order to be authenticated. In accordance with system 100, the HIP component 104 can generate a ‘challenge’ and the authentication component 106 can receive and process the ‘response’ in order to validate and authorize an incoming communication.

In operation, in one example, an incoming call can be received by the communication management component 102 housed within a mobile device. Prior to authorizing the communication, the HIP component 104 can generate a ‘challenge’ (or HIP request) to the caller (or sender). Accordingly, the caller (or sender) addresses the HIP request with a HIP response. This HIP response can be processed by the authentication component 106 whereby a decision can be made to accept or deny the communication.

In a simple example, the challenge/response can be a password-based (or other CAPTCHA-type (Completely Automated Public Turning test to tell Computers and Humans Apart) scheme. These password-based schemes essentially employ a protocol that authenticates as a function of a password, where the challenge prompts for a password and the valid response is the correct password. It will be understood that an adversary capable of eavesdropping on a password authentication can authenticate itself in the same way. One possible solution is to issue multiple passwords, each of them marked with an identifier. Here, the authentication component 106 can select any of the identifiers, and the responder (e.g., caller, sender) must have the correct password for that identifier.

In other examples, the HIP component 104 can employ other protocols to assert challenges other than knowledge of a secret value. For instance, the HIP component 102 can generate HIP requests to determine whether the originator of an incoming communication is real person or a machine. Here, the HIP request can be a distorted series or string of alpha, numeric or alpha-numeric letters/characters by which a user is required to match by typing the string into the device. It is to be understood, because the string is distorted, a machine will be unable to employ optical character recognition techniques (OCR) to decipher the characters in order to automatically respond to the challenge.

Still further, cryptographic mechanisms can be employed to protect challenges and/or responses from eavesdropping. These cryptographic mechanisms (e.g., encryption) can employ hashing algorithms whereby valid challenge/response pairs cannot be recognized by unwanted or malicious agents. Accordingly, the response sent to the authentication component 106 can be decrypted and evaluated upon receipt within the communication management component 102.

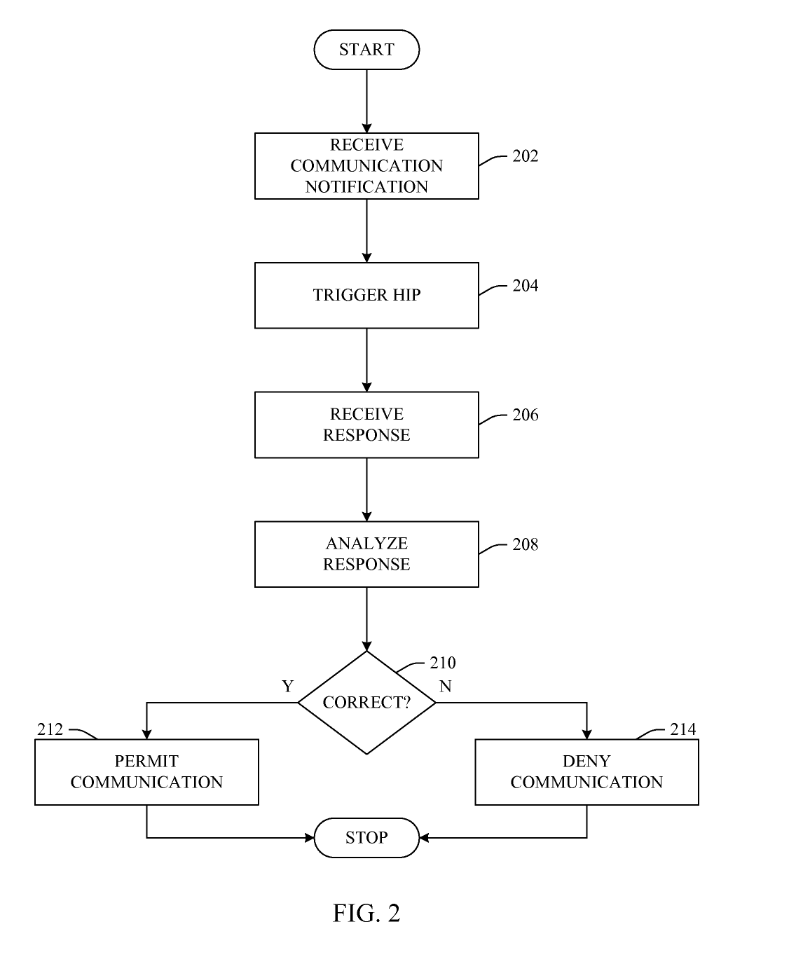

FIG. 2 illustrates a methodology of authenticating a mobile device communication in accordance with an aspect of the innovation. It is to be understood that, in accordance with the innovation, the communication can be a cellular call, a voice-over-Internet (VoIP) call, an electronic mail correspondence (aka email), an instant message (IM), a text message, or the like. Essentially, the features functions and benefits of the innovation can be employed to manage (e.g., authorize) most any incoming communication into a mobile device. Although many of the examples included herein are directed to telephonic voice communications, it is to be understood that the features, functions and benefits of these alternative communication protocols are to be included within the scope of this innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring now to FIG. 2, at 202, a communication notification can be received. For instance, a user can be notified that a call is coming in via an audible or visual notification. Prior to automatically authorizing the communication, at 204, a HIP is triggered. For instance, the HIP can be a ‘challenge’ to the caller to respond to a question, to reproduce a distorted string of characters, to enter a password, etc. Additionally, the HIP can request a biometric input including but, not limited to a fingerprint scan, a retinal scan, a facial scan, a spoken word, or the like.

The response is received at 206 and analyzed at 208. The analysis or evaluation at 208 can effect an authentication decision at 210. Specifically, at 210, a decision can be made if the answer to the challenge is correct or acceptable. In the case of a password, at 210, a decision can be made to determine if the reply matches a correct or acceptable response. Similarly, in the case of biometric analysis, the decision can be made to determine if the information provided in response to a challenge is acceptable to establish an authorized identity.

If deemed correct or acceptable at 210, the communication can be permitted at 212. However, in the event that the response is not correct or acceptable, the communication can be denied at 214. Still further, although not shown, it is to be understood that, if desired, additional challenges can be triggered so as to minimize unintentional denial of communications. Similarly, filters (e.g., white and black lists) can be used to manage access to wanted and likewise unwanted communications.

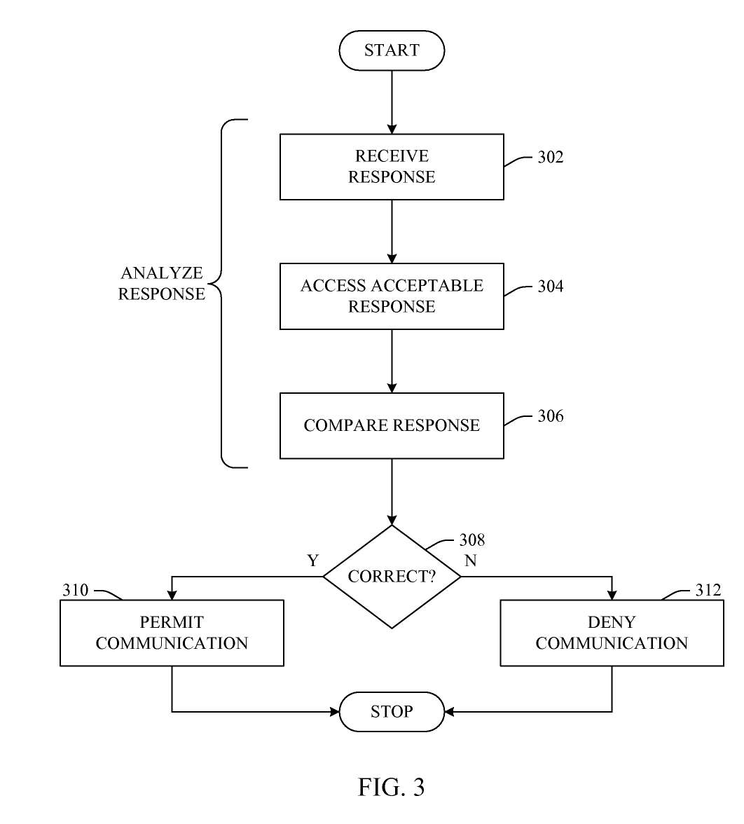

Referring now to FIG. 3, there is illustrated a methodology of analyzing a response to a challenge in accordance with the innovation. At 302, a response to a challenge is received. As described supra, this response can be a keyword/password, secret answer, string of letters and/or characters, a fingerprint, a retinal scan, a facial scan/image, a voice clip or the like. Most any challenge/response mechanisms can be used in accordance with aspects of the innovation.

An acceptable response can be accessed at 304, for example, a filter can be employed in order to determine acceptable and/or unacceptable responses. Similarly, in the case of biometrics, acceptable and/or unacceptable identities can be accessed at 304. At 306, the response can be analyzed and compared to the response(s) retrieved at 304.

A decision can be made at 308 to determine if the response is acceptable by which to permit, or authorize, communication. If acceptable (or correct), at 310, the communication can be permitted to transmit. If however, the authentication is invalid, the communication can be denied to transmit at 312. Here, the caller or sender can be notified that they are not authorized to communicate with the target device. In the event that this denial is questioned, in an aspect, the caller can request an additional challenge by which the methodology can repeat to evaluate the new response. It will be understood that this recursive feature of the analysis methodology can be caller or callee prompted in accordance with aspects of the innovation.

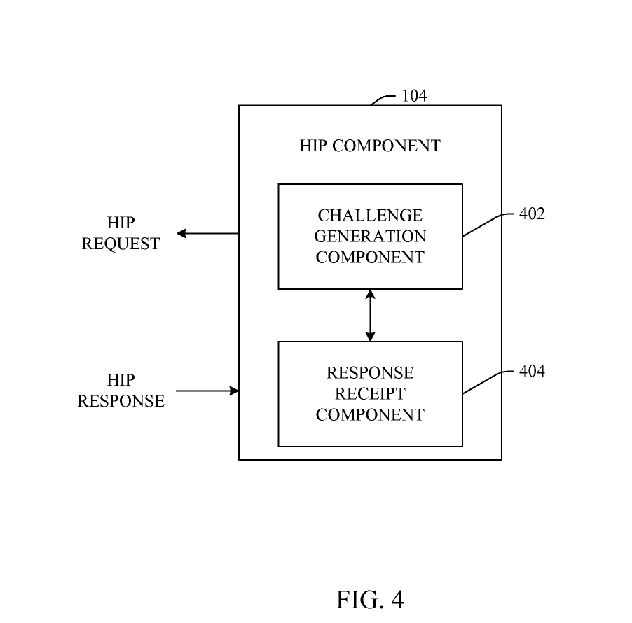

Turning now to FIG. 4, an example HIP component 104 is shown in accordance with an embodiment of the innovation. As shown, the HIP component 104 can include a challenge generation component 402 and a response receipt component 404 that triggers a HIP challenge and response respectively. The HIP challenge can be most any challenge, for example, one that solicits affirmative input or, alternatively, one that captures user specific information. By way of example, the challenge can prompt a user for ‘secret’ information such as a password or other specific identifier that would only be known to an authorized individual. In another example, the challenge can gather biometric information such as a fingerprint, retinal image, facial image, voice signature, handwriting sample, or the like.

The response receipt component 404 can process this information in order to make an authorization decision related to the incoming communication. Continuing with the aforementioned examples, the response receipt component 404 can be used to process the reply (or gathered information) to the challenge. The password can be compared against approved passwords, thereafter; approval can be granted or denied. Similarly, biometric information can be analyzed in order to determine identity of the contactor (e.g., initiator, sender) and thereafter to establish approval/authorization status.

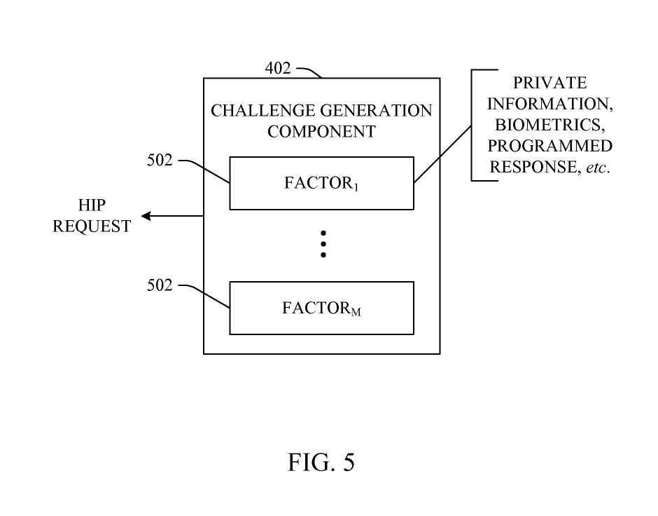

Referring now to FIG. 5, an example block diagram of a challenge generation component 402 is shown. As illustrated, the component 402 can include 1 to M factors 502, where M is an integer. As previously discussed, these factors can be employed to solicit or gather information related to a HIP request. As such, the HIP request can either request information from a user (or device). Alternatively, the HIP request can automatically gather information, for example biometric information, in accordance with the factors 502.

These factors 502 can have most any scope as desired. For instance, the factors 502 can be set and/or defined based upon a level of desired security or other access restriction. The factors 502 can range from passwords, personal information, biometric information, distorted character strings, computational expressions, or the like. It will be appreciated that one goal of the factors is to make it difficult (or impossible) for a machine to respond to the factors 502 set forth in the HIP request.

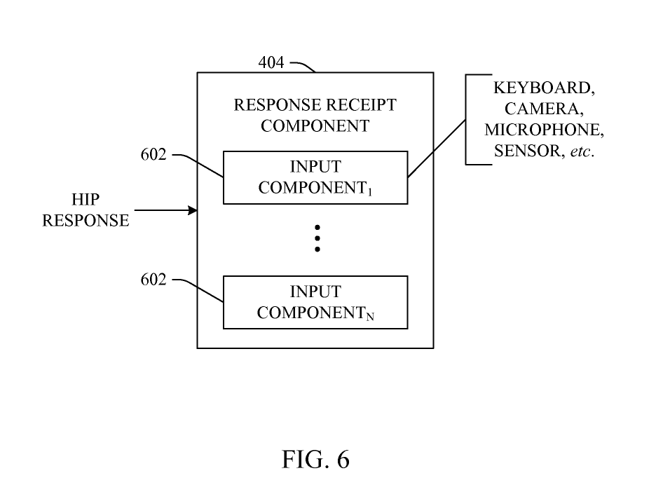

Turning now to FIG. 6, a block diagram of a response receipt component 404 is shown in accordance with an aspect of the innovation. As illustrated, the response receipt component 404 can include 1 to N input components 602, where N is an integer. As described above, the HIP response can be most any input from text (e.g., password, personal information, deciphered text) to audible input (e.g., voice input) to biometric data (e.g., retinal scan, image scan, fingerprint scan).

In order to enter (or receive) the HIP response, 1 to N input components 602 can be employed, where N is an integer. As shown, the input component 602 can include, but is not limited to include, a keyboard, image capture device (e.g., camera, fingerprint capture sensor, retinal scanner), microphone, or other sensory mechanisms. Essentially, it is to be understood that most any HIP challenge/response system can be employed to authorize incoming communications in accordance with aspects of the innovation.

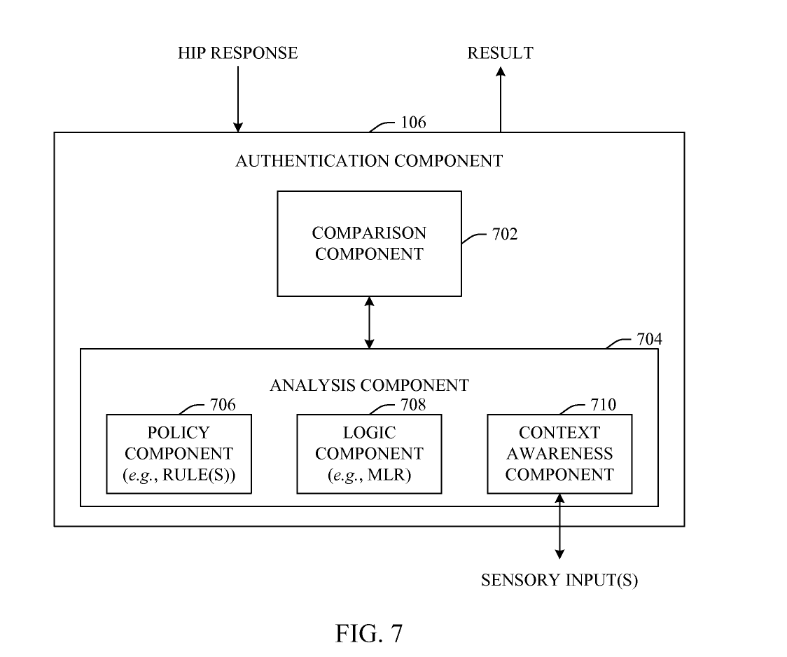

Referring now to FIG. 7, an example authentication component 106 is shown in accordance with an embodiment of the innovation. Generally, the authentication component 106 can include a comparison component 702 and an analysis component 704. Together, these components (702, 704) process HIP responses in order to establish an authorization result which deems a communication permitted and/or denied.

The comparison component 702 employs the analysis component 704 to evaluate the HIP response in order to determine an approval and/or denial result. The analysis component 704 can include a policy component 706, logic component 708 and/or a context awareness component 710. These components (706, 708, 710) facilitate sophisticated and intelligent determination with regard to the approval and/or denial process.

The policy component 706 can include programmed or preprogrammed implementation schemes and/or preferences which can be used to determine approval and/or denial with regard to incoming communications. In accordance with this policy component 706, an implementation scheme (e.g., rule) can be applied to define and/or implement an approval criterion. It will be appreciated that rule-based implementations can automatically and/or dynamically approve or deny incoming communications. In response thereto, the rule-based implementation can analyze criteria included within the HIP response by employing a predefined and/or programmed rule(s) based upon most any desired criteria. Moreover, where textual inputs are received, the authentication component 106 can employ error correction algorithms and schemes that can autocorrect for misspellings, typographical errors or the like, again based upon a predefined correction threshold.

Still further, a rule can be established to permit communication so long as a caller is included within a particular contact list. In other examples, contact ratings can be employed to regulate approval/denial of incoming communications. Still further, contextual factors can be considered in connection with approval/denial of incoming communications. Aspects that employ these contextual awareness factors will be described in greater detail infra.

The logic component 708 can reason to determine if an incoming communication should be approved and/or denied. In one example, the logic component 708 can employ machine learning and reasoning (MLR) schemes to automate one or more features in accordance with the subject innovation. The subject innovation (e.g., in connection with approving and/or denying incoming communication) can employ various MLR-based schemes for carrying out various aspects thereof. For example, a process for determining when to approve a HIP response can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria what type of HIP request to generate, how to transmit the request, when to approve/deny a HIP response, etc.

The context awareness component 710 can be employed to automatically regulate incoming communications as a function of context. For example, the context awareness component 710 can automatically determine context associated with the caller, receiver, or either devices associated therewith. By way of more specific example, global positioning system (GPS) technology can be employed to determine the location of a user. This location information can be used to automatically block incoming communications, unless a determination is made related to unavoidable urgency. In other examples, location of caller, location of receiver, motion (e.g., accelerometer), time of day, date, engaged activity, users within proximity, scheduled appointments (e.g., personal information manager (PIM) data), or the like can be employed by the contextual awareness component 710 to automatically determine whether incoming communication should be approved and/or denied as a function of a particular situation, environment, condition, or the like.

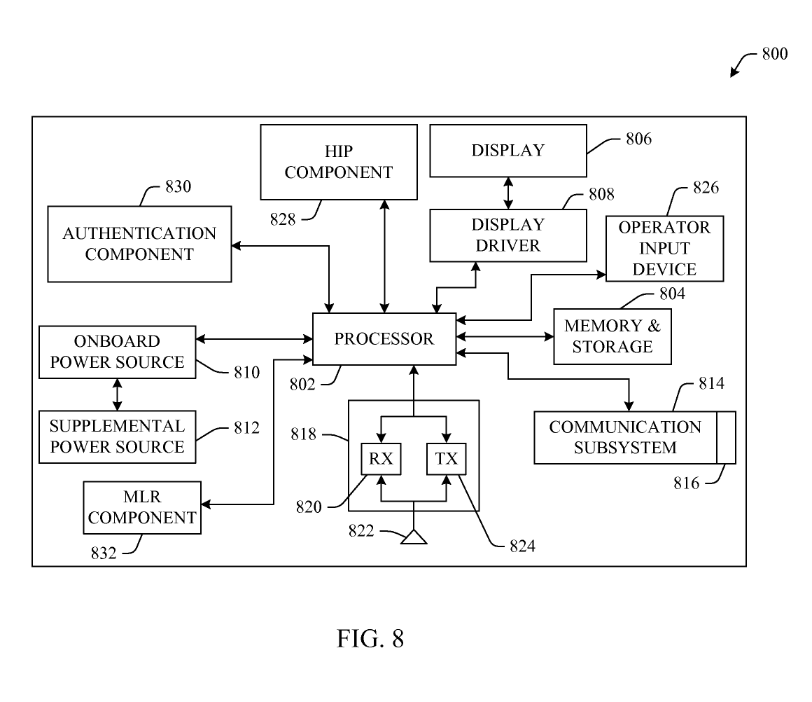

Referring now to FIG. 8, there is illustrated a schematic block diagram of a portable device 800 according to one aspect of the subject innovation, in which a processor 802 is responsible for controlling the general operation of the device 800. It is to be understood that the portable device 800 can be representative of most any portable device including, but not limited to, a cell phone, smartphone, PDA, a personal music player, image capture device (e.g., camera), personal game station, health monitoring device, event recorder component, etc.

The processor 802 can be programmed to control and operate the various components within the device 800 in order to carry out the various functions described herein. The processor 802 can be any of a plurality of suitable processors. The manner in which the processor 802 can be programmed to carry out the functions relating to the subject innovation will be readily apparent to those having ordinary skill in the art based on the description provided herein.

A memory and storage component 804 connected to the processor 802 serves to store program code executed by the processor 802, and also serves as a storage means for storing information such as data, services, metadata, device states or the like. In aspects, this memory and storage component 804 can be employed in conjunction with other memory mechanisms that house health-related data. As well, in other aspects, the memory and storage component 804 can be a stand-alone storage device or otherwise synchronized with a cloud or disparate network based storage means, thereby establishing a local on-board storage of HIP challenge and acceptable response data.

The memory 804 can be a non-volatile memory suitably adapted to store at least a complete set of the information that is acquired. Thus, the memory 804 can include a RAM or flash memory for high-speed access by the processor 802 and/or a mass storage memory, e.g., a micro drive capable of storing gigabytes of data that comprises text, images, audio, and video content. According to one aspect, the memory 804 has sufficient storage capacity to store multiple sets of information relating to disparate services, and the processor 802 could include a program for alternating or cycling between various sets of information corresponding to disparate services.

A display 806 can be coupled to the processor 802 via a display driver system 808. The display 806 can be a color liquid crystal display (LCD), plasma display, touch screen display or the like. In one example, the display 806 is a touch screen display. The display 806 functions to present data, graphics, or other information content. Additionally, the display 806 can display a variety of functions that control the execution of the device 800. For example, in a touch screen example, the display 806 can display touch selection buttons which can facilitate a user to interface more easily with the functionalities of the device 800.

Power can be provided to the processor 802 and other components forming the device 800 by an onboard power system 810 (e.g., a battery pack). In the event that the power system 810 fails or becomes disconnected from the device 800, a supplemental power source 812 can be employed to provide power to the processor 802 (and other components (e.g., sensors, image capture device)) and to charge the onboard power system 810. The processor 802 of the device 800 can induce a sleep mode to reduce the current draw upon detection of an anticipated power failure.

The device 800 includes a communication subsystem 814 having a data communication port 816, which is employed to interface the processor 802 with a remote computer, server, service, or the like. The port 816 can include at least one of Universal Serial Bus (USB) and IEEE 1394 serial communications capabilities. Other technologies can also be included, but are not limited to, for example, infrared communication utilizing an infrared data port, Bluetooth™, etc.

The device 800 can also include a radio frequency (RF) transceiver section 818 in operative communication with the processor 802. The RF section 818 includes an RF receiver 820, which receives RF signals from a remote device via an antenna 822 and can demodulate the signal to obtain digital information modulated therein. The RF section 818 also includes an RF transmitter 824 for transmitting information (e.g., data, service) to a remote device, for example, in response to manual user input via a user input 826 (e.g., a keypad) or automatically in response to a detection of entering and/or anticipation of leaving a communication range or other predetermined and programmed criteria.

A HIP component 828 can be employed to generate and effect receipt of a HIP challenge and/or response. An authentication component 830 can be employed to evaluate a HIP response in order to accept and/or deny incoming communications. Still further, an optional MLR component 832 can be employed to automate one or more features of the innovation. As described in greater detail supra, the MLR component 832 (and/or a rules-based logic component (not shown)) can be used to effect an automatic action of processor 802. It is to be appreciated that these components can enable functionality of like components (and sub-components) described supra.

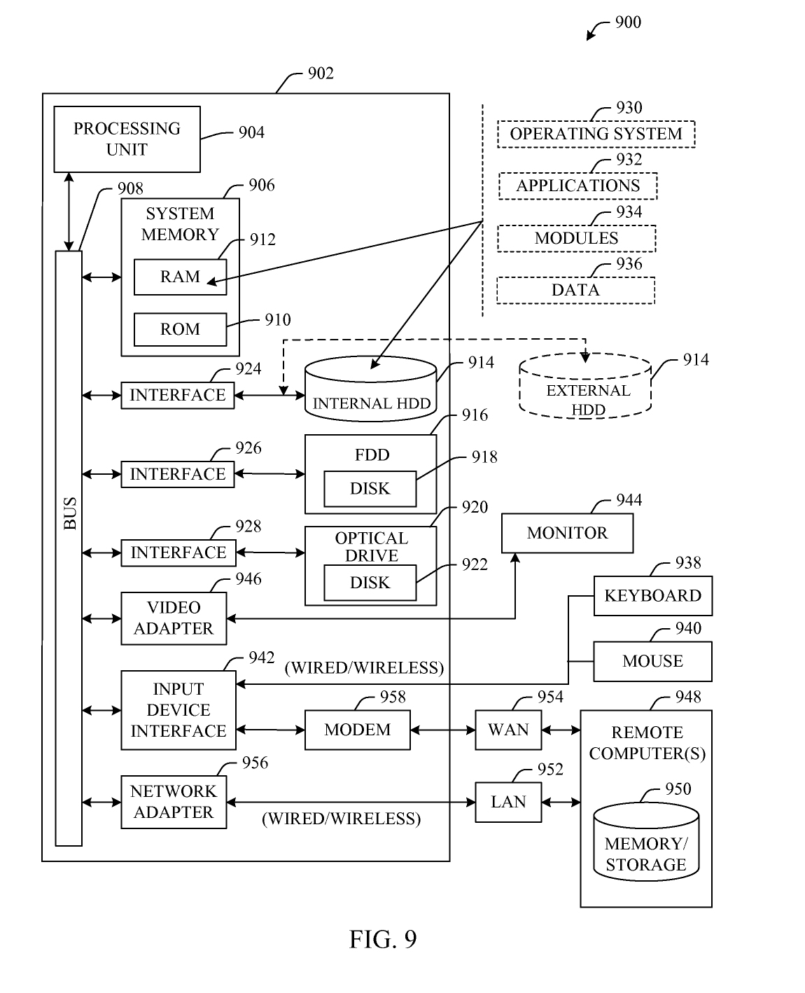

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

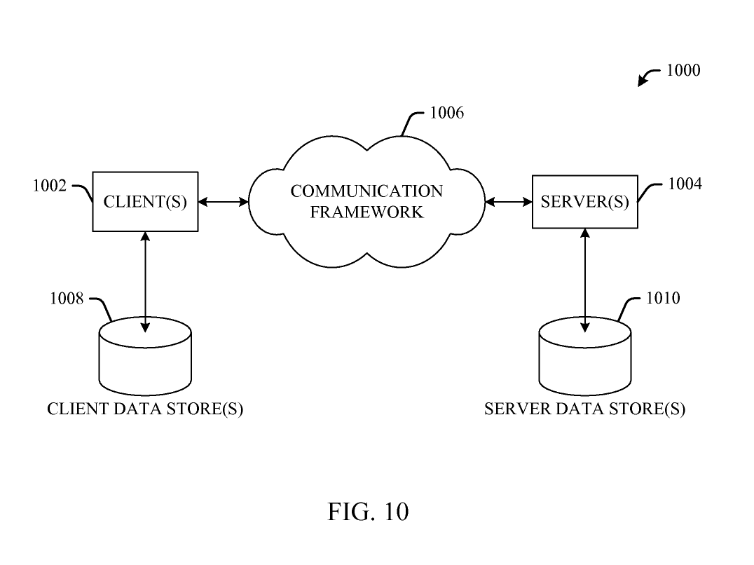

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates management of communication, comprising:
a human interactive program (HIP) component that generates a HIP challenge to an initiator of one of a real-time or non-real-time communication to a mobile device; and
an authentication component that processes a response to the HIP challenge and either accepts or denies the communication as a function of the response, wherein the authentication component is located within the mobile device.

2. The system of claim 1, wherein the communication is a voice call and the mobile device is a cellular telephone.

3. The system of claim 1, wherein the communication is one of an electronic mail, an instant message, a text message, a voice call, or a video call.

4. The system of claim 1, wherein the mobile device is one of a cellular telephone, a smartphone, a personal digital assistant (PDA), or a portable computer.

5. The system of claim 1, further comprising a challenge generation component that establishes the HIP challenge that includes a plurality of factors in accordance with a policy or preference.

6. The system of claim 5, a subset of the factors solicits private information, biometric information, or secret information.

7. The system of claim 1, further comprising a response receipt component that accepts the response via an input component from the initiator of the communication.

8. The system of claim 6, wherein the input component includes at least one of an optical device, a keyboard, a microphone, a physiological sensor or an environmental sensor.

9. The system of claim 1, further comprising:
a comparison component that generates an acceptance or denial result based upon an evaluation; and
an analysis component that establishes the evaluation based at least in part upon one of a policy, logic or context awareness.

10. The system of claim 1, further comprising a machine learning and reasoning (MLR) component that employs at least one of a probabilistic and a statistical-based analysis that infers an action that a user desires to be automatically performed.

11. A computer-implemented method of managing incoming communication via a mobile device, comprising:
receiving an incoming communication from an initiator;
triggering a HIP challenge to the initiator;
receiving a HIP response from the initiator; and
accepting or rejecting the incoming communication based at least in part upon the HIP response.

12. The computer-implemented method of claim 11, further comprising comparing the HIP response to at least one acceptable response.

13. The computer-implemented method of claim 12, further comprising remotely accessing the at least one acceptable response for comparison to the HIP response.

14. The computer-implemented method of claim 12, further comprising establishing context of the mobile device, wherein the context is employed in accepting or rejecting the incoming communication.

15. The computer-implemented method of claim 14, further comprising accessing a plurality of sensory mechanisms to establish the context.

16. The computer-implemented method of claim 11, further comprising:
determining type of the incoming communication; and
generating the HIP challenge based upon the type.

17. A computer-executable system that facilitates access to a mobile device, comprising:
means for receiving an incoming communication;
means for generating a HIP challenge to an initiator of the incoming communication;
means for analyzing a response to the HIP challenge; and
means for authenticating the incoming communication based upon the response.

18. The computer-executable system of claim 17, further comprising means for receiving the response to the HIP challenge.

19. The computer-executable system of claim 17, further comprising means for accessing a policy component, wherein the policy component defines whether to accept or deny the incoming communication based upon the HIP response.

20. The computer-executable system of claim 17, the incoming communication is a voice-over-Internet-protocol (VoIP) call from the initiator.
